(19) United States
(12) Patent Application Publication
(10) Pub. No.: US 2025/0165507 A1
(43) Pub. Date: May 22, 2025

(54) APPARATUS AND METHOD FOR GENERATING STATISTICS BASED ON SPATIAL INFORMATION IN TERMINAL

(71) Applicant: NATIONAL INSTITUTE OF ECOLOGY, Chungcheongnam-do (KR)

(72) Inventors: CHUL HYUN CHOI, Gunsan-si (KR); SUNG RYONG KANG, Gunsan-si (KR); IN YOUNG JANG, Gunsan-si (KR); SANG HAK HAN, Gunsan-si (KR); BO RA KIM, Gunsan-si (KR); EUN JIN PARK, Gunsan-si (KR)

(73) Assignee: NATIONAL INSTITUTE OF ECOLOGY, Chungcheongnam-do (KR)

(21) Appl. No.: 18/627,481

(22) Filed: Apr. 5, 2024

(30) Foreign Application Priority Data
Nov. 16, 2023 (KR) 10-2023-0159007

(51) Int. Cl. G06F 16/29; G06F 16/23; G06F 16/2458

(52) U.S. Cl. CPC G06F 16/29; G06F 16/2365; G06F 16/2462

(57) ABSTRACT

According to an embodiment of the present invention, an apparatus for generating statistics based on spatial information in a terminal includes: a database that stores a plurality of thematic maps for each land use; a communication unit that communicates with an external device; and a control unit that evaluates a plurality of accuracies for the thematic maps for each land use based on verification data when land use statistics are based on spatial data, constructs a land use map by applying a fusion algorithm to the thematic maps for each land use based on the accuracies, and calculates the land use statistics by calculating areas for each land use based on the land use map.

### CROSS-REFERENCE TO RELATED APPLICATION

This application claims under 35 U.S.C. § 119 (a) the benefit of Korean Patent Application No. 10-2023-0159007 filed on Nov. 16, 2023, the entire contents of which are incorporated herein by reference.

### BACKGROUND

### (a) Technical Field

The present invention relates to a terminal, and particularly to an apparatus and method for generating statistics based on spatial information in a terminal.

### (b) Background Art

In order to cope with climate change, the international community stipulates an agreement (Paris Agreement) to calculate and submit each country's greenhouse gas emissions and apply a measurement, report, and verification (hereinafter referred to as ‘MRV’) system so that greenhouse gas emissions can be verified in other countries. According to the classification of the intergovernmental panel on climate change (hereinafter referred to as ‘IPCC’), the calculation of the greenhouse gas emissions includes energy, industrial processes, agriculture, land use, and waste field, and the greenhouse gas emissions from 1990 to the latest year that can be calculated should be reported. In particular, the land use sector should be treated with importance because it uniquely contains a unique sink.

However, the existing statistics on land use (forest land, agricultural land, grassland, wetland, and settlement) are managed by ministries, but are constructed based on administrative data, so there may be areas that are spatially overlapping or missing, or may be inconsistent with current land use.

In particular, the land use area was calculated based on basic forest statistics for the forest land, agricultural area surveys for the agricultural land, and cadastral statistics for the grassland, wetland, and settlement. In principle, the standard presented by the IPCC is that the sum of all land use areas should be consistent with the national land area. However, when the land use area is summed based on the existing statistics, the land use area is 96,177 km², but when comparing the summed land use area with the total area of the country is 100,432 km² as of 2021, there is a difference of about 4.2%.

In addition, the cadastral statistics may differ from actual land use because a land designation is maintained when an individual does not apply for land designation change, etc. For example, when there are no special administrative sanctions on land that is currently used as a rice field (land designation ‘rice pad’), even the current settlement (land designation ‘land’) may be maintained as it is in many cases.

Problems with the land use statistics described above may lead to errors when calculating greenhouse gases caused by land use change. Therefore, the need for a method to solve these problems has emerged.

### SUMMARY OF THE DISCLOSURE

An embodiment of the present invention provides an apparatus and method for generating statistics based on spatial information in a terminal capable of improving accuracy by minimizing errors in land use statistics.

According to an embodiment of the present invention, an apparatus for generating statistics based on spatial information in a terminal includes: a database that stores a plurality of thematic maps for each land use; a communication unit that communicates with an external device; and a control unit that evaluates a plurality of accuracies for the thematic maps for each land use based on verification data when land use statistics are based on spatial data, constructs a land use map by applying a fusion algorithm to the thematic maps for each land use based on the accuracies, and calculates the land use statistics by calculating areas for each land use based on the land use map.

A method of generating statistics based on spatial information in a terminal includes: evaluating, by a control unit, accuracies of a plurality of thematic maps for each land use stored in a database based on verification data when land use statistics are based on spatial data; applying, by the control unit, a fusion algorithm to the thematic maps for each land use based on the accuracies; constructing, by the control unit, a land use map by fusing the maps; and calculating, by the control unit, the land use statistics by calculating areas for each land use based on the land use map.

According to an embodiment of the present invention, it is possible to improve accuracy by generating the statistics based on the spatial information in the terminal to minimize the errors in land use statistics.

In addition, the effects obtainable or predicted by the embodiments of the present invention will be disclosed directly or implicitly in the detailed description of the embodiments of the present invention. That is, various effects predicted according to embodiments of the present invention will be disclosed in the detailed description to be described later.

### BRIEF DESCRIPTION OF THE DRAWINGS

FIG. 1 is a block configuration diagram of a terminal according to an embodiment of the present invention.

FIG. 2 is a flowchart of generating land use statistics in a terminal according to an embodiment of the present invention.

FIG. 3 is a flowchart of fusing thematic maps for each land use in the terminal according to the embodiment of the present invention.

FIG. 4 is a diagram illustrating an operation of fusing the thematic maps for each land use according to the embodiment of the present invention.

FIG. 5 is a diagram illustrating the generated land use statistics according to the embodiment of the present invention.

### DETAILED DESCRIPTION

After terms used in the present specification are briefly described, the present disclosure will be described in detail.

General terms that are currently widely used were selected as terms used in exemplary embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the present invention. Therefore, the terms used in exemplary embodiments of the present invention should be defined on the basis of the meaning of the terms and the contents throughout the present invention rather than simple names of the terms.

Since the present disclosure may be variously modified and have several exemplary embodiments, specific exemplary embodiments of the present disclosure will be illustrated in the drawings and be described in detail in the detailed description. However, it is to be understood that the present invention is not limited to specific exemplary embodiments, but includes all modifications, equivalents, and substitutions without departing from the scope and spirit of the present invention. When it is decided that a detailed description for the known art related to the present disclosure may obscure the gist of the present disclosure, the detailed description will be omitted.

Terms “first,” “second,” and the like, may be used to describe various components, but the components are not to be construed as being limited by these terms. The terms are used only to distinguish one component from another component.

Singular forms are intended to include plural forms unless the context clearly indicates otherwise. It will be further understood that terms “include” or “formed of” used in the present specification specify the presence of features, numerals, steps, operations, components, parts, or combinations thereof mentioned in the present specification, but do not preclude the presence or addition of one or more other features, numerals, steps, operations, components, parts, or combinations thereof.

In embodiments, a ‘module’ or a ‘˜er/or’ may perform at least one function or operation, and be implemented by hardware or software or be implemented by a combination of hardware and software. In addition, a plurality of “modules” or a plurality of “˜ers/ors” may be integrated in at least one module and be implemented by at least one processor (not illustrated) except for a ‘module’ or an ‘˜er/or’ that needs to be implemented by specific hardware.

In an embodiment of the present invention, when any one part is referred to as being “connected to” another part, it means that any one part and another part are “directly connected to” each other or are “electrically connected to” each other with still another part interposed therebetween. In addition, unless explicitly described to the contrary, “including” any component will be understood to imply the inclusion of other components rather than the exclusion of other components.

Hereinafter, exemplary embodiments of the present disclosure will be described in detail with reference to the accompanying drawings so that those skilled in the art to which the present disclosure pertains may easily practice the present disclosure. However, the present disclosure may be implemented in various different forms and is not limited to exemplary embodiments described herein. In addition, in the drawings, portions unrelated to the description will be omitted to clearly describe the present invention, and similar portions will be denoted by similar reference numerals throughout the specification.

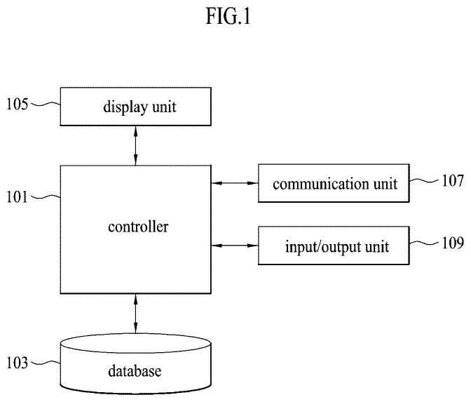

FIG. 1 is a block configuration diagram of a terminal according to an embodiment of the present invention.

Referring to FIG. 1, the terminal includes a control unit 101, a database 103, a display unit 105, a communication unit 107, and an input/output unit 109.

Looking at each component, the database 103 stores various programs and data necessary for an operation of the terminal. For example, the database 103 may store a plurality of thematic maps for each land use. For example, the thematic maps for each land use may be at least one of the thematic maps related to forest land, agricultural land, grassland, wetland, and settlement. For example, the database 103 may be implemented by a non-volatile memory, a volatile memory, a flash-memory, a hard disk drive (HDD), a solid state drive (SDD), or the like.

The display unit 105 displays image data under the control of the control unit 101. The implementation method of the display unit 105 is not limited and implemented in various types of displays such as a liquid crystal display (LCD), an organic light emitting diode (OLED) display, an active-matrix organic light-emitting diode (AM-OLED), and a plasma display panel (PDP). The display unit 105 may additionally include an additional component according to the implementation scheme. For example, when the display unit 105 is the liquid crystal display panel, the display unit 105 includes an LCD display panel (not illustrated), a backlight unit (not illustrated) that supplies light to the display panel, and a panel driving substrate (not illustrated) that drives the panel. The display unit 105 may be coupled to a touch panel (not illustrated) of an input/output unit 109 to be provided as a touch screen (not illustrated).

The communication unit 107 provides data transmission and reception functions of the terminal. For example, the communication unit 107 may transmit a data request message requesting data on land use statistics to at least one external device under the control of the control unit 101. The communication unit 107 may receive the data on land use statistics from at least one external device in response to the data request message.

The input/output unit 109 receives various commands from a user or outputs various data to the external device. For example, the input/output unit 109 may include at least one of a keyboard, a mouse, a key, a touch panel, and a pen recognition panel.

The control unit 101 controls the overall operation of the terminal using various programs stored in the database 103.

For example, the control unit 101 may confirm whether the land use statistics are based on spatial data. For example, the land use statistics may be stored in advance in the database 103.

As a result of the confirmation, when the land use statistics are not the spatial data, the control unit 101 may collect the data on land use statistics. For example, the control unit 101 may transmit the data request message to at least one external device through the communication unit 107. The control unit 101 may receive the data on land use statistics from at least one external device through the communication unit 107 in response to the data request message and store the data on land use statistics in the database 103, thereby collecting the data on land use statistics.

In addition, the control unit 101 may confirm whether the thematic maps for each land use exist in the collected data on land use statistics.

As a result of the confirmation, when there are no thematic maps for each land use, the control unit 101 may calculate the land use statistics based on non-spatial data. Here, the method of calculating land use statistics based on non-spatial data corresponds to Approach 1 among the statistical calculation methods presented by the IPCC, and this step is a step of simply presenting areas for each land use. For reference, Approach 2 is a step of presenting area changes between land uses, and Approach 3 is the step of identifying spatial changes between the land uses. The method proposed in the present invention corresponds to Approach 3, is based on maps, etc., and is used in developed countries.

When the land use statistics are based on the spatial data or there are the thematic maps for each land use, the control unit 101 may confirm the thematic maps for each land use in the database 103. For example, when the statistics for each land use are based on the spatial data, the control unit 101 may confirm the thematic maps for each land use that need to be updated. As another example, when the statistics for each land use are not based on the spatial data, the control unit 101 may confirm the thematic maps for each land use to improve the land use statistics.

In addition, the control unit 101 may confirm whether verification data for the thematic maps for each land use exists in the database 103 for accuracy evaluation.

As a result of the confirmation, when there is no verification data, the control unit 101 may construct the verification data for the thematic maps for each land use. Here, sample points that may confirm actual land use are used to construct the verification data. The number of sample points is calculated using, for example, an equation for calculating the minimum number of sample points, which is mainly used in the field of remote sensing. For example, the control unit 101 may determine the number of sample points using Equation 1 below:

$$N = ( B \times P ( 1 - P ) ) / {E}^{2} \qquad [ Equation 1 ]$$

wherein, N denotes the minimum number of sample points, B denotes a chi-square critical value (5.695), P denotes a proportion of land use classes having a proportion closest to 50%, and E denotes a tolerance (5%).

In more detail, the control unit 101 may determine the number of sample points using Equation 1. For example, when 0.654, the current statistical forest ratio as of 2021, is applied to P, the minimum number of sample points may be derived as 516 (5.695 Y 0.654 Y (1-0.654)/0.052) through Equation 1.

Meanwhile, in order to construct the verification data, 516 sample points are required from the overall region, which may be divided into five regions considering Korea's regional characteristics (metropolitan area, Gangwon area, Honam area, Gyeongsang area, and Jeju area). When 516 sample points are set per region, the control unit 101 may determine the total number of sample points to be 2,580.

Then, the control unit 101 prepares a distribution map of sample points for each region. For example, when preparing a sample point distribution for each region, the control unit 101 may select a method of minimizing statistical bias, such as a random sampling method or a systematic sampling method.

Meanwhile, land use survey standards for the sample points are set by referring to IPCC guidelines, standards used when preparing current statistical data, etc. The land use survey method may use a geographic information system (hereinafter, referred to as GIS) program or the like that may confirm high-resolution images of land use in time series that can be read with the naked eye. For example, the GIS program may be the Google Earth program provided by Google, which may provide images of the overall Earth with annual aerial image resolution (within 1 m).

In addition, the control unit 101 may increase the reliability of reading by using various auxiliary data (time series index data using remote sensing techniques, etc., various administrative information related to land use such as development, logging, land reclamation, reclamation, etc.) related to land use together with high-resolution images. The control unit 101 may complete the survey of 2,580 points and complete the construction of verification data based on the completed survey.

When the verification data exists or has been constructed, the control unit 101 may use the verification data to evaluate the accuracy of the thematic maps for each land use. For example, among accuracy evaluation methods, there may be a method of preparing a confusion matrix and then calculating overall accuracy, precision, recall, or F1-Score. Among these, the F1-Score may be used to evaluate the accuracy of uneven data between types, such as land use.

For example, a method of evaluating accuracy of each of the thematic maps for each land use may evaluate a forest type map and a farm map that include only a single land use attribute by dividing these maps into dichotomous data such as forest land and non-forest land, and agricultural land and non-agricultural land. For a continuous cadastral map and a land cover map with attributes of all land use types, forest land, agricultural land, grassland, wetland, and settlement may all be evaluated. The accuracy evaluation method for each thematic map may vary depending on the accuracy evaluation method, but the accuracy for each land use type should be able to be evaluated.

For example, when the accuracy is calculated through the F1-Score as of 2021, the forest type map may be evaluated as 0.72 (0.81 for non-forest land and 0.60 for forest land), the farm map may be evaluated as 0.79 (0.95 for non-agricultural land and 0.62 for agricultural land), the continuous cadastral map may be evaluated as 0.24 (0.37 for forest land, 0.17 for agricultural land, 0.12 for grassland, 0.10 for wetland, and 0.42 for settlement), and the land cover map may be evaluated as 0.61 (0.60 for forest land, 0.58 for agricultural land, 0.49 for grassland, 0.80 for wetland, and 0.56 for settlement).

The control unit 101 may apply a fusion algorithm to the thematic maps for each land use using the accuracy of the thematic maps for each land use. For example, the fusion algorithm may minimize problems such as duplication, omission, or inconsistency in the land use statistics.

To describe the operation of the fusion algorithm in more detail, the control unit 101 may confirm the thematic maps for each land use for which accuracy evaluation has been completed. For example, the thematic maps for each land use may include a forest type map (prepared by the Korea Forest Service) in relation to forest land, a farm map (prepared by the Ministry of Agriculture, Food and Rural Affairs) in relation to agricultural land, a continuous cadastral map (prepared by the Ministry of Land, Infrastructure and Transport), and land cover map (prepared by the Ministry of Environment). Here, the continuous cadastral map and land cover map include not only grassland, wetland, and settlement, but also forest and agricultural land boundary information, so it includes the overall land use attribute. In contrast, the forest type map and farm map include only forest and farmland attribute information, respectively, and thus include a single attribute.

In addition, the control unit 101 may select one of all the land use thematic maps and confirm whether the corresponding land use thematic map includes the overall land use attribute. For example, when the corresponding land use thematic map is the continuous cadastral map or land cover map, the control unit 101 may determine that the corresponding land use thematic map includes the overall land use attribute. As another example, when the corresponding land use thematic map is the forest type map or farm map, the control unit 101 may determine that the corresponding land use thematic map does not include the overall land use attribute.

As a result of the confirmation, when the corresponding land use thematic map includes the overall land use attribute, the control unit 101 may determine the corresponding land use thematic map to be a background map.

The control unit 101 may confirm whether the thematic maps for all the land uses have been confirmed. As a result of the confirmation, when all the thematic maps for each land use are confirmed, the control unit 101 may compare the accuracy between the determined background maps and confirm the background map with the highest accuracy. For example, the control unit 101 may finally select a background map with high accuracy among the continuous cadastral map and the land cover map determined as the background map.

As a result of the confirmation, when the corresponding land use thematic map does not include the overall land use attribute, the control unit 101 may determine the corresponding land use thematic map to be a single attribute update map.

The control unit 101 may confirm whether the thematic maps for all the land uses have been confirmed. As a result of the confirmation, when all the thematic maps for each land use are confirmed, the control unit 101 may compare the accuracy between the determined single attribute update maps and confirm the single background map with the highest accuracy. For example, the control unit 101 may select the single background map with high accuracy among the forest type map and the farm map determined as the single attribute update map.

The control unit 101 may compare the accuracy between each of the single attribute update maps and the background map to confirm the single attribute update map with lower accuracy than the background map among the single attribute update maps. The control unit 101 may perform filtering to exclude the confirmed single attribute update map among the single attribute update maps.

The control unit 101 may determine the priority between the background map and the plurality of single attribute update maps. For example, the control unit 101 may determine the background map as the lowest priority. Then, the control unit 101 determines the next ranking among the single attribute update maps in descending order according to the accuracy ranking. Therefore, the single attribute update map with the highest accuracy may be ranked first, the single attribute update map with the next highest accuracy may be ranked second, and the background map may be ranked lowest.

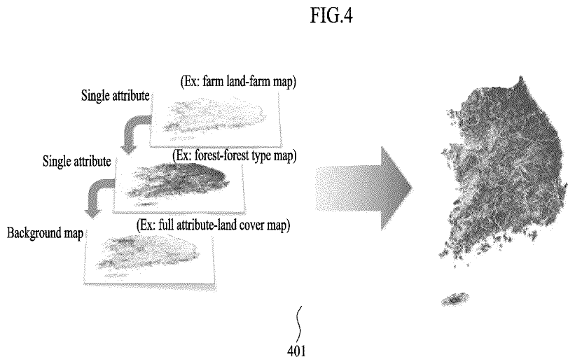

The control unit 101 may arrange the high-rank map at the top according to the ranking. Therefore, the first-rank map may be arranged at the top, and the lowest-rank map may be arranged at the bottom. For example, as illustrated in FIG. 4, when the farm map, which is the single attribute update map, is ranked first, the forest type map, which is the single attribute update map, is ranked second, and the land cover map, which is the background map, is ranked third, the farm map may be arranged at the top, the forest type map may be arranged next, and the land cover map may be arranged at the bottom.

The control unit 101 may construct the land use map using the arranged maps. For example, the control unit 101 may construct the land use map by fusing map layers arranged according to ranking by giving priority to map attributes arranged at the top using a spatial information analysis tool, etc.

In this way, arranging the background map at the bottom of the land use map is to solve the problem of missing attributes. Meanwhile, the attribute of the land use map gives priority to the attribute of the map located at the top. Through the method, the duplication and omission problems in the land use statistics may be effectively solved, and the priority determination based on accuracy may automatically minimize mismatch errors.

In addition, the control unit 101 may calculate the land use statistics based on the spatial data by calculating the areas for each land use using the constructed land use map.

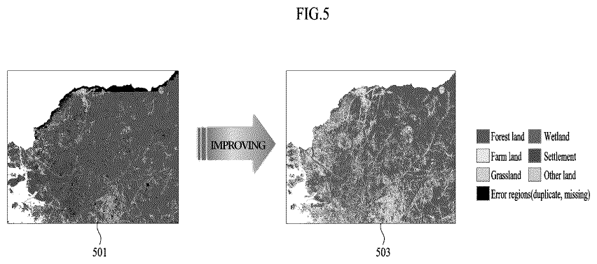

Through this operation, according to an embodiment of the present invention, it is possible to improve accuracy by generating the statistics based on the spatial information in the terminal to minimize the errors in the land use statistics. For example, as illustrated in FIG. 5, the difference in the summed area of the land use types compared to the national land for the existing land use map 501 may be 4.2%, and the difference in the summed area of the land use types compared to the national land for a land use map 503 of the present invention may be 0.4%. In other words, the present invention improves accuracy by reducing the difference in the summed area of the land use types compared to the national land from 4.2% to 0.4% compared to the existing method.

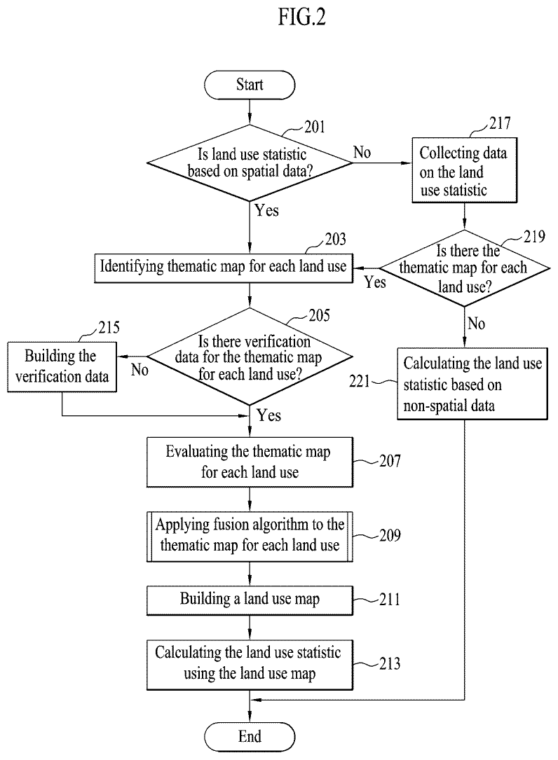

FIG. 2 is a flowchart of generating land use statistics in a terminal according to an embodiment of the present invention.

Referring to FIG. 2, in step 201, the control unit 101 confirms whether the land use statistics are based on the spatial data. For example, the land use statistics may be stored in advance in the database 103.

As a result of the confirmation, when the land use statistics are the spatial data, the control unit 101 proceeds to step 203, and otherwise, proceeds to step 217.

When proceeding to step 217, the control unit 101 collects data on land use statistics and then proceeds to step 219. For example, the control unit 101 may transmit the data request message to at least one external device through the communication unit 107. The control unit 101 may receive the data on land use statistics from at least one external device through the communication unit 107 in response to the data request message and store the data on land use statistics in the database 103, thereby collecting the data on land use statistics.

In step 219, the control unit 101 confirms whether the thematic maps for each land use exist in the collected data on land use statistics.

As a result of the confirmation, when the thematic maps for each land use exist, the control unit 101 proceeds to step 203, and otherwise, proceeds to step 221.

When proceeding to step 221, the control unit 101 calculates the land use statistics based on the non-spatial data.

When proceeding to step 203, the control unit 101 confirms the thematic maps for each land use in the database 103 and then proceeds to step 205. For example, when the statistics for each land use are based on the spatial data, the control unit 101 may confirm the thematic maps for each land use that need to be updated. As another example, when the statistics for each land use are not based on the spatial data, the control unit 101 may confirm the thematic maps for each land use to improve the land use statistics.

In step 205, the control unit 101 confirms whether verification data for the thematic maps for each land use exists in the database 103 for accuracy evaluation.

As a result of the confirmation, when there is the verification data, the control unit 101 proceeds to step 207, and otherwise, proceeds to step 215.

When proceeding to step 215, the control unit 101 constructs the verification data for the thematic maps for each land use and then proceeds to step 207. For example, the control unit 101 may determine the number of sample points using the above Equation 1.

In more detail, the control unit 101 determines the number of sample points using Equation 1. For example, when 0.654, the current statistical forest ratio as of 2021, is applied to P, the minimum number of sample points may be derived as 516 (5.695×0.654×(1−0.654)/0.052) through the Equation 1.

Meanwhile, in order to construct the verification data, 516 sample points are required from the overall region, which may be divided into five regions considering Korea's regional characteristics (metropolitan area, Gangwon area, Honam area, Gyeongsang area, and Jeju area). When 516 sample points are set per region, the control unit 101 may determine the total number of sample points to be 2,580.

Then, the control unit 101 prepares a distribution map of sample points for each region. For example, when preparing a sample point distribution for each region, the control unit 101 may select a method of minimizing statistical bias, such as a random sampling method or a systematic sampling method.

Meanwhile, land use survey standards for the sample points are set by referring to IPCC guidelines, standards used when preparing current statistical data, etc. The land use survey method uses, for example, a GIS program that may confirm land use in time series using high-resolution images that can be read with the naked eye.

The control unit 101 completes the survey of 2,580 points and completes the construction of verification data based on the completed survey.

When proceeding to step 207, the control unit 101 evaluates the accuracy of the thematic maps for each land use using the verification data and then proceeds to step 209.

For example, a method of evaluating accuracy of each of the thematic maps for each land use may evaluate a forest type map and a farm map that include only a single land use attribute by dividing these maps into dichotomous data such as forest land and non-forest land, and agricultural land and non-agricultural land. For a continuous cadastral map and a land cover map with attributes of all land use types, types of forest land, agricultural land, grassland, wetlands, settlement, etc., may all be evaluated. The accuracy evaluation method for each thematic map may vary depending on the accuracy evaluation method, but the accuracy for each land use type should be able to be evaluated.

For example, when the accuracy is calculated through the F1-Score as of 2021, the forest type map may be evaluated as 0.72 (0.81 for non-forest land and 0.60 for forest land), the farm map may be evaluated as 0.79 (0.95 for non-agricultural land and 0.62 for agricultural land), the continuous cadastral map may be evaluated as 0.24 (0.37 for forest land, 0.17 for agricultural land, 0.12 for grassland, 0.10 for wetland, and 0.42 for settlement), and the land cover map may be evaluated as 0.61 (0.60 for forest land, 0.58 for agricultural land, 0.49 for grassland, 0.80 for wetland, and 0.56 for settlement).

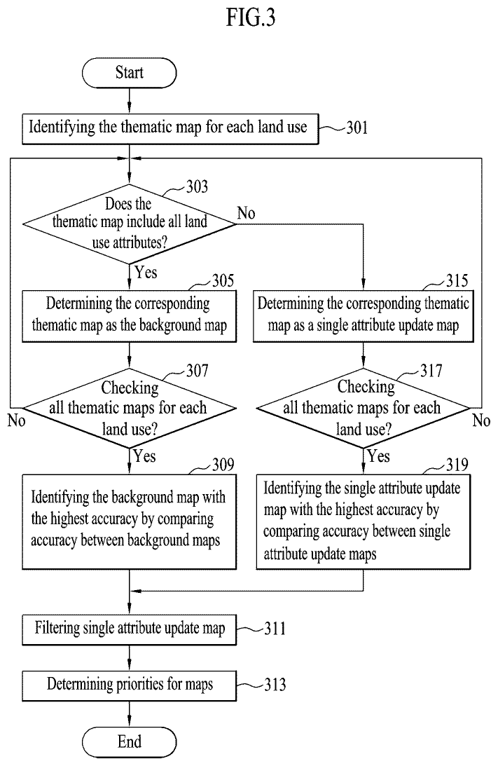

In step 209, the control unit 101 applies the fusion algorithm to the thematic maps for each land use using the accuracy of the thematic maps for each land use, and then proceeds to step 211. For example, the fusion algorithm may minimize problems such as duplication, omission, or inconsistency in the land use statistics. From now on, referring FIG. 3, the process of applying the fusion algorithm to the thematic maps for each land use will be described in detail.

Referring to FIG. 3, the control unit 101 confirms the thematic maps for each land use for which the accuracy evaluation has been completed in step 301 and then proceeds to step 303.

For example, the thematic maps for each land use may include a forest type map (prepared by the Korea Forest Service) in relation to forest land, a farm map (prepared by the Ministry of Agriculture, Food and Rural Affairs) in relation to agricultural land, a continuous cadastral map (prepared by the Ministry of Land, Infrastructure and Transport), and land cover map (prepared by the Ministry of Environment). Current representative land use-related thematic maps were used as examples, but thematic maps may be added later.

In step 303, the control unit 101 selects one of all thematic maps for each land use and confirms whether the corresponding land use thematic map includes the overall land use attribute. For example, when the corresponding land use thematic map is the continuous cadastral map or land cover map, the control unit 101 may determine that the corresponding land use thematic map includes the overall land use attribute. As another example, when the corresponding land use thematic map is the forest type map or farm map, the control unit 101 may determine that the corresponding land use thematic map does not include the overall land use attribute.

As a result of the confirmation, when the corresponding land use thematic map includes all the land use attributes, the control unit 101 proceeds to step 305, and otherwise, proceeds to step 315.

When proceeding to step 305, the control unit 101 determines the corresponding land use thematic map to be the background map and then proceeds to step 307.

In step 307, the control unit 101 confirms whether all the thematic maps for each land use have been confirmed. As a result of the confirmation, when all the thematic maps for each land use are confirmed, the control unit 101 proceeds to step 309, and otherwise, proceeds to step 303.

When proceeding to step 309, the control unit 101 compares the accuracy among the determined background maps to confirm the background map with the highest accuracy, and then proceeds to step 311. For example, the control unit 101 may confirm a background map with high accuracy among the continuous cadastral map and the land cover map determined as the background map.

When proceeding to step 315, the control unit 101 determines the corresponding land use thematic map to be the single attribute update map and then proceeds to step 317.

In step 317, the control unit 101 confirms whether all the thematic maps for each land use have been confirmed. As a result of the confirmation, when all the thematic maps for each land use are confirmed, the control unit 101 proceeds to step 319, and otherwise, proceeds to step 303.

In step 319, the control unit 101 compares the accuracy between the determined single attribute update maps to confirm the single attribute update map with high accuracy, and then proceeds to step 311. For example, the control unit 101 may confirm the single attribute update map with high accuracy among the forest type map and the farm map determined as the single attribute update map.

In step 311, the control unit 101 compares the accuracy between each of the single attribute update maps and the background map to confirm the single attribute update map with lower accuracy than the background map among the single attribute update maps. The control unit 101 performs filtering to exclude the confirmed single attribute update map among the single attribute update maps, and then proceeds to step 313.

In step 313, the control unit 101 determines the priority between the background map and the plurality of single attribute update maps.

For example, the control unit 101 may determine the background map as the lowest priority. The control unit 101 determines ranking among the single attribute update maps in descending order according to the accuracy. Therefore, the single attribute update map with the highest accuracy may be ranked first, the single attribute update map with the next highest accuracy may be ranked second, and the background map may be ranked lowest. The control unit 101 may arrange a high-rank single attribute update map at the top according to the ranking. The background map may be arranged at the bottom.

For example, when the farm map, which is the single attribute update map, is ranked first, the forest type map, which is the single attribute update map, is ranked second, and the land cover map, which is the background map, is ranked third, as illustrated in FIG. 4, the farm map is arranged at the top, the forest type map is arranged next, and the land cover map is arranged at the bottom.

The control unit 101 may construct the land use map using the arranged maps. For example, the control unit 101 may construct the land use map by fusing the arranged map layers by giving priority to map attributes arranged at the top using a spatial information analysis tool, etc.

In this way, arranging the background map at the bottom of the land use map is to solve the problem of missing attributes. Meanwhile, the attribute of the land use map gives priority to the attribute of the map located at the top. Through the method, the duplication and omission problems in the land use statistics may be effectively solved, and the priority determination based on accuracy may automatically minimize mismatch errors.

Returning to FIG. 2, in step 211, the control unit 101 constructs the land use map and then proceeds to step 213. For example, the control unit 101 may construct the land use map by applying the fusion algorithm of the thematic maps using the spatial information analysis tool, etc.

In step 213, the control unit 101 calculates the land use statistics based on the spatial data by calculating the areas for each land use using the constructed land use map.

Through this operation, according to an embodiment of the present invention, it is possible to improve accuracy by generating the statistics based on the spatial information in the terminal to minimize the errors in the land use statistics.

Although exemplary embodiments of the present invention have been illustrated and described, the present invention is not limited to the above-mentioned specific exemplary embodiment, but may be variously modified by those skilled in the art to which the present invention pertains without departing from the spirit and scope of the present invention as claimed in the claims. In addition, such modifications should also be understood to fall within the scope of the present invention.

1. An apparatus for generating statistics based on spatial information in a terminal, comprising:
a database that stores a plurality of thematic maps for each land use;
a communication unit that communicates with an external device; and
a control unit that evaluates a plurality of accuracies for the thematic maps for each land use based on verification data when land use statistics are based on spatial data, generates a plurality of ranked maps by applying a fusion algorithm to the thematic maps for each land use based on the accuracies, constructs a land use map by fusing the maps according to the ranking, and calculates the land use statistics by calculating areas for each land use based on the land use map.

2. The apparatus of claim 1, wherein the control unit confirms attributes of each of the thematic maps for each land use, determines the plurality of thematic maps for each land use having an overall land use attribute from among the thematic maps for each land use as a plurality of background maps, compares accuracies between the background maps to select a background map having highest accuracy from among the background maps, determines the plurality of thematic maps for each land use having a single attribute among the thematic maps for each land use as a plurality of single attribute update maps, confirms accuracy of the single attribute update maps, determines the confirmed background map as a lowest ranking of the land use map and then arranges the background map at a bottom, and arranges the single attribute update maps starting from a top in order of high accuracy and then sets the map attribute arranged at the top as the attribute of the land use map.

3. The apparatus of claim 2, wherein the control unit compares the accuracy between each of the single attribute update maps and the confirmed background map to filter out the single attribute update map whose accuracy is lower than the confirmed background map from among the single attribute update maps.

4. The apparatus of claim 1, wherein the control unit collects data on the land use statistics from the external device through the communication unit when the land use statistics are not based on the spatial data, and calculates the land use statistics based on non-spatial data when the thematic maps for each land use do not exist in the collected data.

5. The apparatus of claim 1, wherein the thematic maps for each land use include the thematic maps related to land use of a serial cadastral map, a land cover map, a forest type map, and a farm map.

6. A method of generating statistics based on spatial information in a terminal, comprising:
evaluating, by a control unit, accuracies of a plurality of thematic maps for each land use stored in a database based on verification data when land use statistics are based on spatial data;
fusing, by the control unit, a plurality of maps by applying a fusion algorithm to the thematic maps for each land use based on the accuracies;
constructing, by the control unit, a land use map by fusing the maps; and
calculating, by the control unit, the land use statistics by calculating areas for each land use based on the land use map.

7. The method of claim 6, wherein the fusing of the maps includes:
confirming attributes of each of the thematic maps for each land use;
determining the plurality of thematic maps for each land use having an overall land use attribute from among the thematic maps for each land use as a plurality of background maps;
comparing accuracies between the background maps to select a background map having highest accuracy from among the background maps;
determining the plurality of thematic maps for each land use having a single attribute among the thematic maps for each land use as a plurality of single attribute update maps;
comparing accuracy between the single attribute update maps;
determining the confirmed background map as a lowest-rank map which is a bottom of the land use map;
determining next ranking among the single attribute update maps in descending order according to the accuracy ranking; and
fusing the land use map by determining an arrangement order of the confirmed single attribute update map and the confirmed background map.

8. The method of claim 7, wherein the determining of the plurality of thematic maps for each land use having the single attribute among the thematic maps for each land use as the plurality of single attribute update maps further includes comparing the accuracy between each of the single attribute update maps and the confirmed background map to filter out the single attribute update map whose accuracy is lower than the confirmed background map from among the single attribute update maps.

9. The method of claim 6, further comprising:
collecting, by the control unit, data on the land use statistics from an external device through a communication unit when the land use statistics are not based on the spatial data, and
calculating, by the control unit, the land use statistics based on non-spatial data when the thematic maps for each land use do not exist in the collected data.

10. The method of claim 6, wherein the thematic maps for each land use include the thematic maps related to land use of a serial cadastral map, a land cover map, a forest type map, and a farm map.
